(19) United States
(12) Patent Application Publication
(10) Pub. No.: US 2006/0151688 A1
(43) Pub. Date: Jul. 13, 2006

(54) System and method for metabonomics directed processing of LC-MS or LC-MS/MS data

(75) Inventors: Jose Castro-Perez, Manchester (GB); Robert Plumb, Milford, MA (US); Hilary Major, Cheshire (GB); Steve Preece, Cheshire (GB); Martin Lunt, Lancashire (GB); Jeffrey Goshawk, Lancashire (GB); Marc V. Gorenstein, Needham, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle (DE)

(21) Appl. No.: 11/288,588

(22) Filed: Nov. 29, 2005

Related U.S. Application Data
(63) Continuation of application No. PCT/US04/16797, filed on May 26, 2004.
(60) Provisional application No. 60/474,499, filed on May 29, 2003.

(51) Int. Cl. B01D 59/44

(52) U.S. Cl. 250/284; 250/288

(57) ABSTRACT

A method of programmatically reducing a set of collected LC-MS or LC-MS/MS data such that true chromatographic and MS peaks are identified for use in Metabonomics is disclosed. The identified peaks are used to create a list of LC/MS, GC/MS, DIOS-MS or MALDI-MS signals and responses for a batch of samples which appear in a Master Entity List. The samples in the Master Entity List are then subjected to isotope de-clustering and adduct removal prior to chemometrics being applied to automatically identify biomarkers. An LC-MS/MS or LC/MS, GC/MS, DIOS-MS or MALDI-MS acquisition list is generated for the signals identified as responsible for the PLS-DA or PCA separation. The LC or GC retention time, exact mass and MS/MS spectrum may be compared to databases of known compounds and identified compounds associated with biological parameters may be stored in a new compound database.

### CROSS REFERENCE TO RELATED APPLICATIONS

This application claims benefit of and is a continuation of International Application No. PCT/US2004/016797, filed May 26, 2004 and designating the United States, which claims benefit of a priority to U.S. Provisional Application No. 60/474,499, filed May 29, 2003. The content of which is expressly incorporated herein by reference in its entirety.

### FIELD OF THE INVENTION

The illustrative embodiment of the present invention relates generally to metabolic analysis and more particularly to the programmatic processing of LC-MS and LC-MS/MS data for peak deconvolution and subsequent chemometric analysis.

### BACKGROUND

Metabolism may be defined as the chemical changes that take place in a cell or organisms that are used to produce energy and the basic materials which are needed for important life processes such as mitosis. The byproducts of the chemical reaction may be referred to as metabolites. By analyzing and identifying the metabolites that are present in a sample, it is possible to determine the route of metabolism. For example, an analysis of metabolites in biofluids such as urine may be used to determine what substances were ingested by the individual that produced the urine. The identification and analysis of the metabolites is often performed using liquid chromatography in combination with mass spectrometry. The profiling of complex metabolic patterns in biofluids is referred to as metabonomics.

Liquid chromatography separates the individual components contained within a sample so that they may be identified. In liquid chromatography two phases are involved, a mobile phase and a stationary phase. A liquid sample mixture (the “mobile phase”) is passed through a column packed with particles (the “solid phase”) in order to effect a separation of the constituent components. The particles in the column may or may not be coated with a liquid designed to interact with the mobile phase. The constituent components in the mobile phase (i.e.: in the sample) pass through the packed column at different rates based upon a number of factors. The separation of the sample into its constituent components is then analyzed by observing the sample as it exits the far end of the column.

The speed with which the different constituent components pass through the column depends on the interaction of the mobile phase with the solid phase. The components in the sample may physically interact with the particles or a substance coating the particles such that their movement through the column is retarded. Different components in the sample being analyzed will react differently to the particular particle and/or coating by interacting with the particular particles and/or coating with differing degrees of strength depending upon the chemical makeup of the component. Those components which have a greater affinity for the particles and/or coating will pass through the column more slowly than those components which bond weakly or not at all with the particle/coating. In addition to chemical reactions, the size of the components in the sample may dictate the speed with which they pass through the column. For example, in gel-permeation chromatography, different molecules in the solution being analyzed pass through a matrix containing pores at different speeds thereby effecting a separation of the different molecules in the sample. In size exclusion chromatography the size of the particles and their packing method in the column combine with the size of the components in the sample to determine the rate at which a sample passes through the column (as only certain size components may easily traverse the gaps/interstitial spaces between particles).

The separated sample travels into a detector at the far end of the column where the retention time is calculated for the various components in the sample. The retention time is the time required for the sample to travel from the injection port (where the sample is introduced into the column) through the column and to the detector. The amount of the component exiting the solid phase may be graphed against the retention time to form a chart with peaks which are known as chromatographic peaks. The peaks identify the different components.

The separated components may be fed into a mass spectrometer for further analysis in order to determine their chemical make-up. Systems that have one mass spectrometer stage combined with a liquid chromatography stage are referred to as LC-MS systems. Systems with two mass spectrometer stages are referred to as LC-MS/MS systems. A mass spectrometer takes a sample as input and ionizes the sample to create either positive or negative ions. A number of different ionization methods may be used including the use of an electrospray ionization. The ions are then separated by the mass to charge ratio in a first stage separation commonly referred to as MS1. The mass separation may be accomplished by a number of means including the use of magnets which divert the ions to differing degrees based upon the weight of the ions. The separated ions then travel into a collision cell where they come in contact with a collision gas or other substance which interacts with the ions. The reacted ions then undergo a second stage of mass separation commonly referred to as MS2.

The separated ions are analyzed at the end of the mass spectrometry stage (or stages). The analysis graphs the intensity of the signal of the ions versus the mass of the ion in a graph referred to as a mass spectrum. The analysis of the mass spectrum gives both the masses of the ions reaching the detector and the relative abundances. The abundances are obtained from the intensity of the signal. The combination of liquid chromatography with mass spectrometry may be used to identify chemical substances such as metabolites. When a molecule collides with the collision gas covalent bonds often break, resulting in an array of charged fragments. The mass spectrometer measures the masses of the fragments which may then be analyzed to determine the structure and/or composition of the original molecule. This feature is significantly enhanced from nominal mass MS when using a mass spectrometer capable of accurate mass measurements e.g. hybrid quadrupole orthoganol TOF instrument or FTICR, allowing analyte elemental composition information to be derived. This information may be used to isolate a particular substance in a sample.

Chemometrics is the mathematical treatment of data such as LC-MS/MS data and includes types of multi-variate analysis such as PCA (Principle Component Analysis) and PLS-DA (Partial Least Squares-Discriminate Analysis) or similar statistical approaches. Chemometrics attempts to reduce large amounts of data to a manageable size and apply a statistically driven model in order to determine latent variables indicative of hidden relationships between the observed data. Chemometrics may thus be applied to the field of metabonomics. Unfortunately, conventional methods of data acquisition often lose valuable relevant data in the process of reducing the collected data set as the processing/collecting of MS data for chemometric analysis is reliant upon the summing of the whole MS spectrum and thus results in the loss of any retention time data. Additionally, conventional methods do not integrate the raw data, filtered data and statistical analysis into a single data processing application with the result that the mapping of the raw data to filtered data to analyzed data is awkward at best.

### SUMMARY OF THE INVENTION

The illustrative embodiment of the present invention provides an automated mechanism for rapidly reducing the set of collected LC/MS or LC-MS/MS data such that true chromatographic and MS peaks are identified. The identified peaks are used to create a list of LC/MS signals and responses for a batch of samples which appear in a Master Entity List. The samples in the Master Entity List can then subjected to isotope de-clustering and adduct removal prior to chemometrics being applied to automatically identify biomarkers. An LC-MS/MS acquisition list is generated for the signals identified as responsible for the PLS-DA or PCA group clustering or separation. The LC retention time, accurate mass and MS/MS spectrum may be compared to databases of known compounds and identified compounds associated with biological parameters may be stored in a new compound database.

### BRIEF DESCRIPTION OF THE DRAWINGS

FIG. 1 depicts an environment suitable for practicing the illustrative embodiment of the present invention;

FIG. 2 is a flow chart of the sequence of steps used to perform liquid chromatography and mass spectrometry;

FIG. 3 depicts a visual display of a Sample List generated by the illustrative embodiment of the present invention;

FIG. 4 depicts a visual display of a Master Entity List generated by the illustrative embodiment of the present invention

FIG. 5A depicts a visual display of the loadings plot markers graph generated by the illustrative embodiment of the present invention;

FIG. 5B depicts a visual display of a trends plot graph generated by the illustrative embodiment of the present invention;

FIG. 6 depicts a visual display of the scores plot graph showing group similarities generated by the illustrative embodiment of the present invention

FIG. 7 is a flow chart of the overall sequence of steps followed by the illustrative embodiment of the present invention to perform metabonomics-directed processing of LC-MS/MS data; and

FIG. 8 is a flow chart of the sequence of steps followed by the illustrative embodiment of the present invention to perform chemometric analysis.

### DETAILED DESCRIPTION

The illustrative embodiment of the present invention provides a mechanism for using chemometric analysis on programmatically filtered LC-MS or LC-MS/MS data for the purpose of determining metabonomic profiles. Collected LC-MS or LC-MS/MS data is programmatically filtered to determine true chromatographic and MS peaks. A Master Entity List is created from the LC-MS or LC-MS/MS signals and responses for a batch of samples. The samples in the Master Entity List are further filtered and chemometrics are applied to automatically identify metabonomic biomarkers.

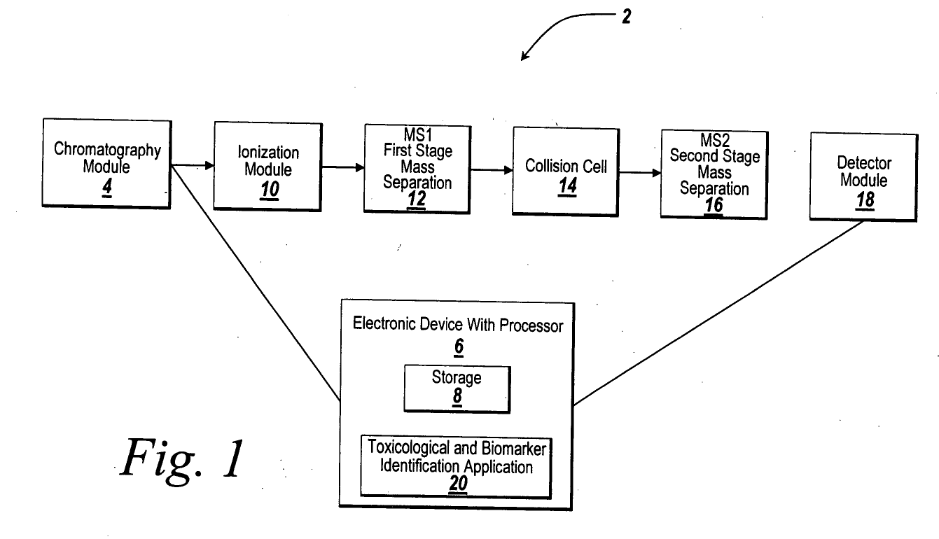

Data for the illustrative embodiment of the present invention is performed in a metabolite analyzing system such as an LC-MS/MS system as depicted in FIG. 1. Other types of metabolic analyzing systems such as LC/MS systems may be used instead of an LC-MS/MS system without departing from the scope of the present invention. Those skilled in the art will recognize that this approach could also be applied to the analysis of LC-UV or other similar hyphenated chromatographic techniques such as GC-MS and DIOS-MS as well as MALDI-MS (Matrix Assisted Laser Desorption/Ionization-Mass Spectroscopy)-MS and DIOS-MS. The metabolite analyzing system 2 includes a chromatography module 4, such as a liquid chromatography module. Also included is an ionization module 10. The ionization module 10 receives as an input sample the output from the chromatography module 4. The ionization module performs ionization of the sample. Those skilled in the art will recognize that there are a number of different ways in which the sample may be ionized, such as by bombarding the sample with a stream of high energy electrons.

The ions produced by the ionization module 10 are passed on to the MS1 first stage mass separation module 12. The mass separation may be performed using any of a number of well-known techniques. For example, the ions may be subjected to magnetic forces which alter the path of the ions based upon the mass of the ion. The separated ions are then be passed into a collision cell module 14 where they are subjected to additional reactions, such as exposure of the ions to a gas designed to react with the separated ions. The sample may be further separated in an MS2 second stage mass separation module 16 prior to arriving at a detector module 18. The detector module 18 is used to generate a mass spectrum based on the detected signal generated by the exiting ions. Those skilled in the art will recognize that a number of different methods of mass separation may be used and different substances may be introduced into the collision cell 14 in order to react with the ions of particular interest. Similarly, the illustrative embodiment of the present invention may also be performed with a number of different metabolite analyzing systems including an LC-MS system performing only one stage of mass separation.

An electronic device with a processor 6 is interfaced with the detector module 18 and the chromatography module 4. The electronic device 6 may be a server, desktop computer system, laptop, mainframe, network attached device or some other similar device with a processor. The electronic device may also be integrated into one of the modules in the metabolite analyzing system 2 without departing from the scope of the present invention. The electronic device 6 includes storage 8 which is used to record the results of sample runs. Those skilled in the art will recognize that the storage 8 may be located in any location accessible to the metabolite analyzing system 2. Also located on the electronic device 6 is a Toxicological Screening and Biomarker Identification application 20 that may be used to identify biomarkers for different types of Systems Biology such as Metabonomics, Functional Genomics, Peptidomics, Lipidomics, Glycomics and Proteomics. Those skilled in the art will recognize that this approach could also be used for natural product evaluation, impurity profiling, environmental analysis, food and nutrition and product release. The Toxicological Screening and Biomarker Identification Application 20 is discussed further below. Those skilled in the art will recognize that the Toxicological Screening and Biomarker Application 20 may be located in any location in which it can access the saved raw LC-MS or LC-MS/MS data, including being integrated into the modules of the metabolite analyzing system 2 or on a separate electronic device.

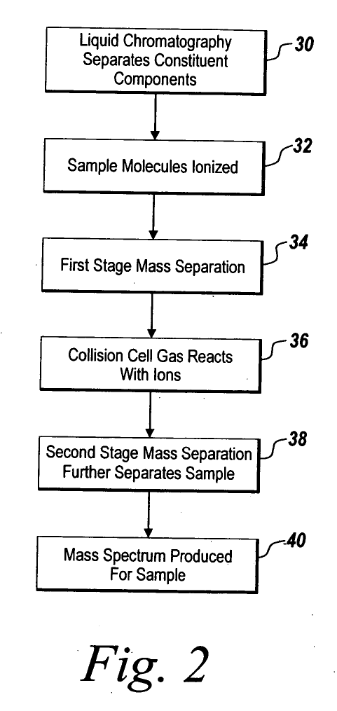

The sequence of steps performed to conduct a single LC-MS or LC-MS/MS run to collect raw data is depicted in the flow chart of FIG. 2. The sequence begins with a liquid chromatography separation of the components in a sample (step 30). The sample components exiting from the liquid chromatography system are passed into the ionization module 10 where ionization is performed (step 32). The first stage of mass separation is performed (step 34) and the separated ions are passed into the collision cell where they react to the collision cell reactant (step 36). Second stage mass separation is then performed on the reacted ions exiting from the collision cell (step 38). The separated ions are passed into the detector module 18 where a mass spectrum is generated from collected data thereby enabling the identification of metabolites contained within the sample (step 40).

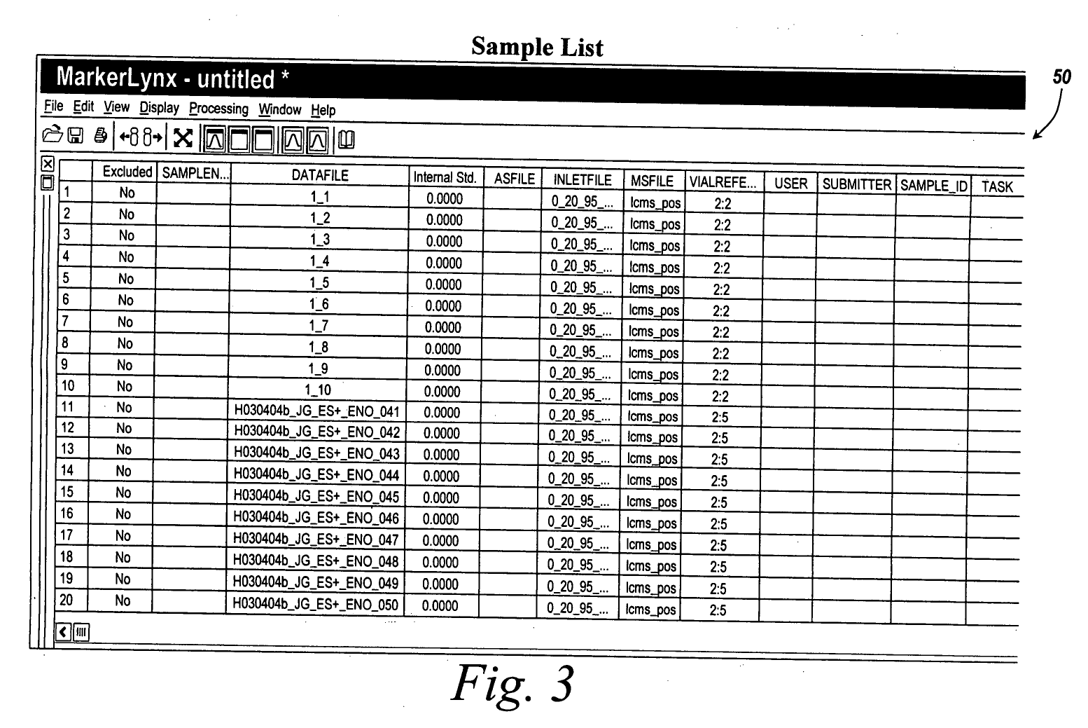

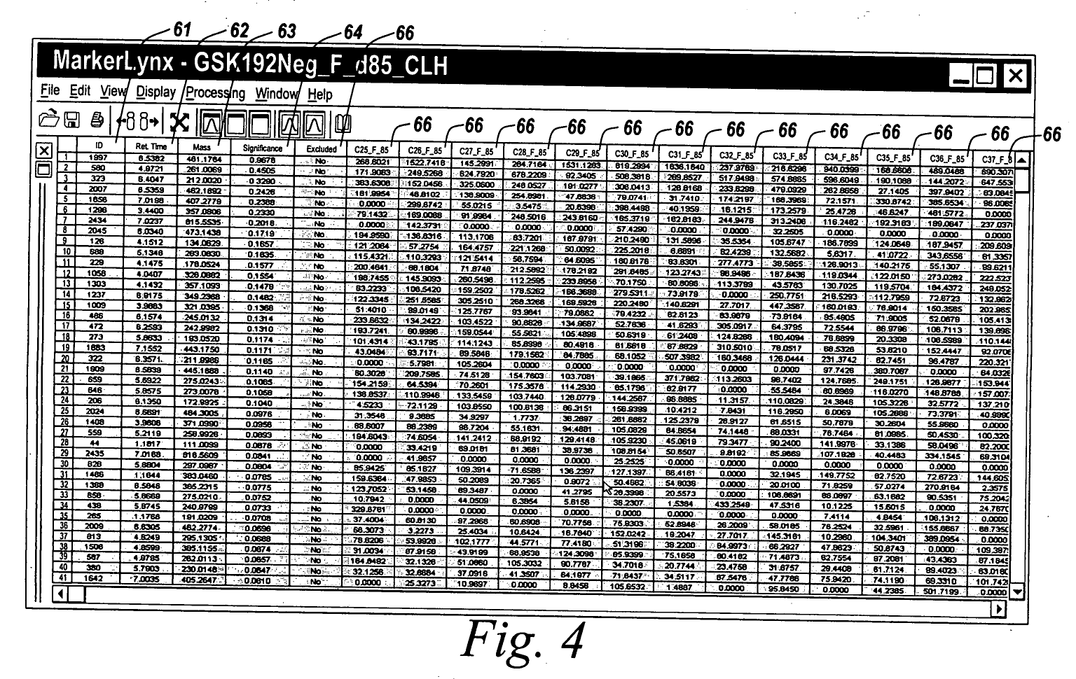

Once the raw LC-MS or LC-MS/MS data has been collected, the illustrative embodiment of the present invention works to identify true chromatographic and MS peaks. The Toxicological Screening and Biomarker Identification Application 20 performs peak deconvolution on the raw LC and MS data. Peak deconvolution identifies the actual analyte signal peaks and filters out noise from the raw LC and MS data. The Toxicological Screening and Biomarker Identification Application 20 next creates a sample list of signals. FIG. 3 depicts a Sample List 50 of signals. The Sample List 50 is used to create a batch of samples from the signals and responses that appear in a Master Entity List 60. FIG. 4 depicts a display of a Master Entity List 60 that is generated by the illustrative embodiment of the present invention. Each sample in the Master Entity List 60 includes an ID 61, a Retention Time 62, a Mass 63, a Significance 64, an Exclusion value 65, and ion intensity/response value columns 66. As an example, each response value column may be for a separate test animal. The Master Entity List lists all of the similarities of two different groups and may exclude certain masses. Every true peak or analyte detected by the system in each sample is cross-referenced with each of the other samples programmatically. Samples missing a signal are assigned a value.

The Toxicological Screening and Biomarker Identification Application 20 then further filters the sample data. The samples undergo isotope de-clustering and adduct removal to remove unwanted trace elements. Adduct removal refers to the removal of ion such as sodium and potassium or dimmer/trimers etc which if unaccounted for can skew the analysis of the collected data.

Once the samples have undergone isotope de-clustering and adduct removal, the Toxicological Screening and Biomarker Identification Application 20 uses chemometric analysis to identify potential biomarkers in the sample data. The chemometric analysis will identify clusters of interest among the samples. The clusters represent similarities among the samples and are used to identify the metabonomic profiles. A number of different types of chemometric analysis may be used including PCA and PLS-DA.

For example, Principal Component Analysis (PCA) uses mathematical algorithms to determine the differences and similarities in a data set. PCA transforms a number of possibly related variables into a smaller number of unrelated variables which are referred to as principle components. The first principle component accounts for as much of the variability in the data as possible. Each additional component attempts to account for as much of the remaining variability in the data as possible. The collected data may be arranged in a matrix and PCA solves for eigenvalues and eigenvectors of a square symmetric matrix with sums of squares and cross products. The eigenvector associated with the largest eigenvalue has the same direction as the first principle component. The eigennvector associated with the second greatest eigenvalue determines the direction of the second principle component. The sum of the eigenvalues equals the trace of the square matrix and the maximum number of eigenvectors equals the numbers of rows (or columns) of this matrix. Once determined, it is possible to draw screen plots of the calculated eigenvalues. Those skilled in the art will recognize that a number of different algorithms may be used to calculate the eigenvalues and eigenvectors. The data is displayed using two plots: i) the scores plot which shows the group clustering and ii) the loadings plot in which the analytes/ions responsible for the group clustering are identified as those being the greatest distance from the origin.

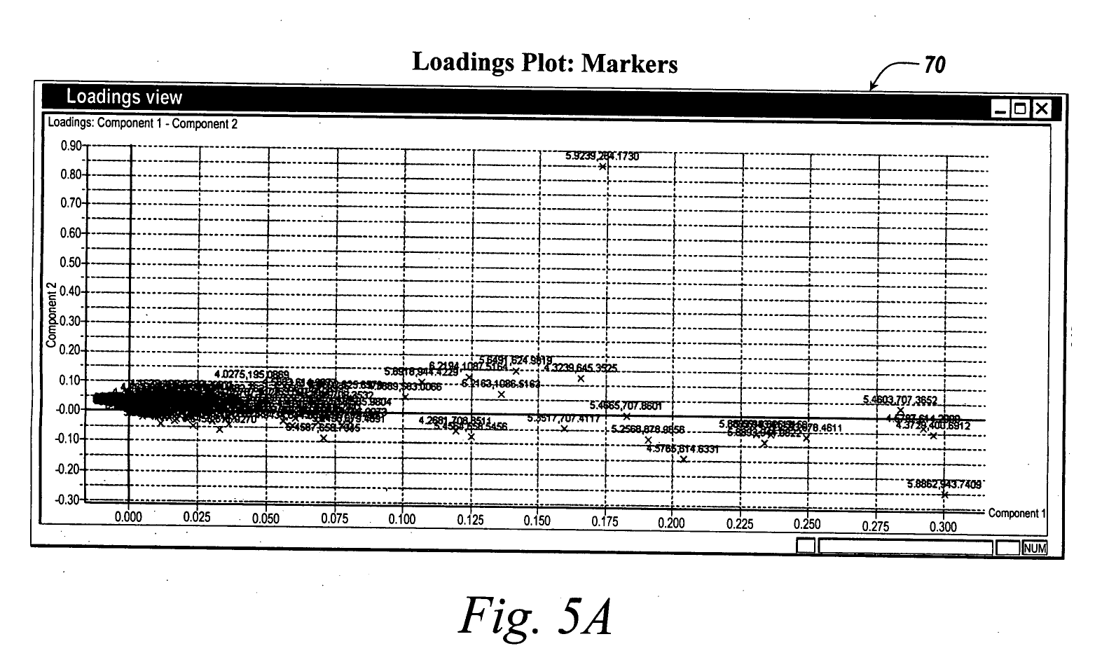

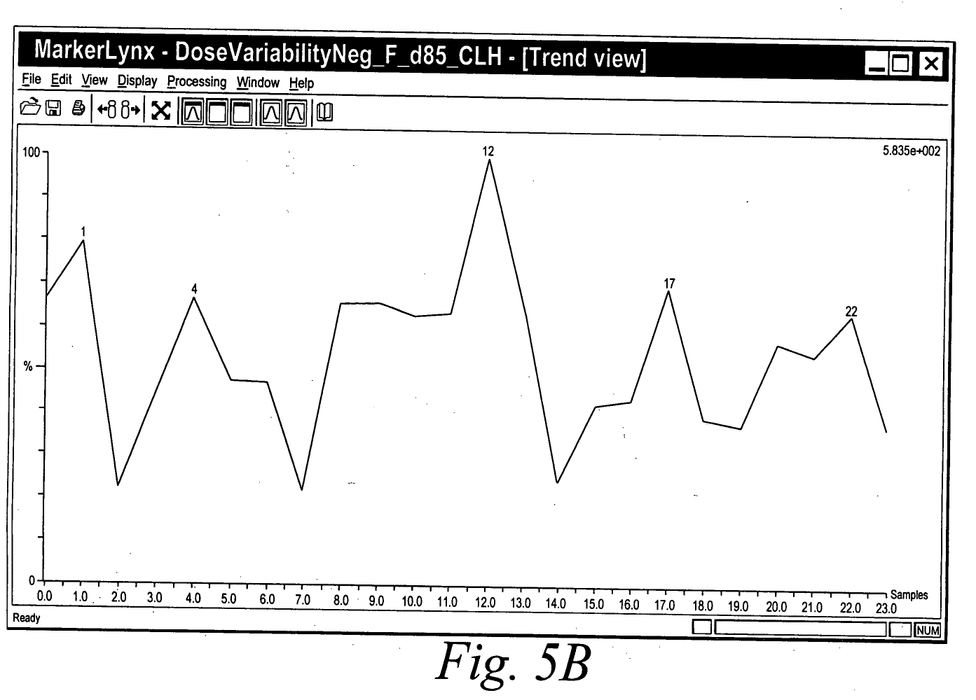

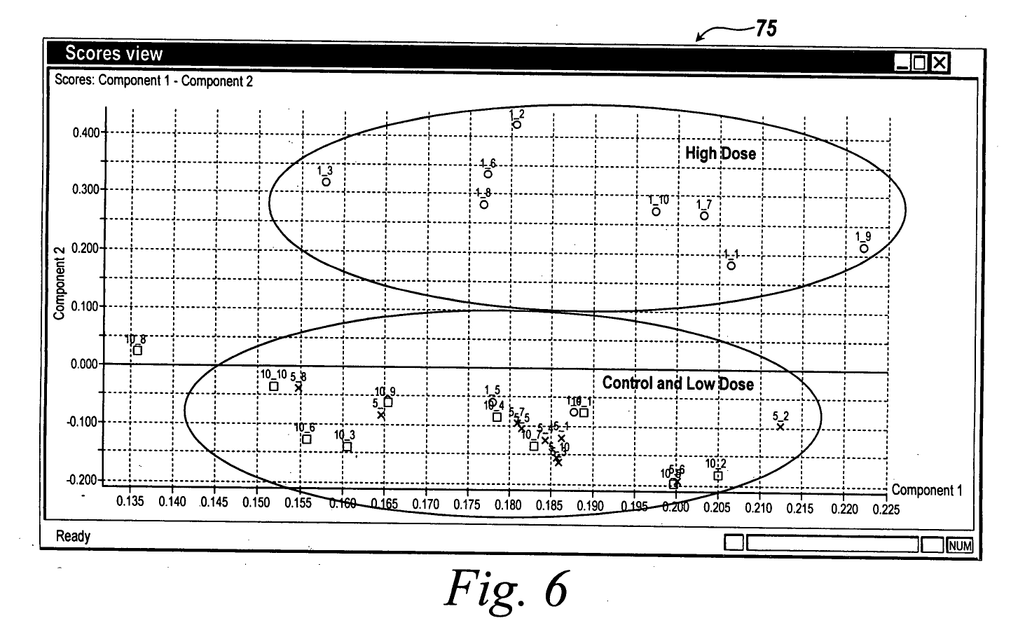

Chemometric analysis is used to determine latent variables which represent hidden connections between data points. Each data sample has a number of features such as signal intensity, mass and retention time. The chemometric analysis applies a function to the features and graphs the result of the function on an n dimensional plot. Conventional methods of processing the data for plotting involve bucketing data from time intervals of the sample run. This results in the loss of the retention time variable. The illustrative embodiment of the present invention presents a Loadings Plot 70 as shown in FIG. 5A showing the analytes peak of the various markers. The ions the greatest distance from the origin, using eigen vectors, are those most responsible for the group clustering or separation. The Loading Plot 70 may also be used to create a Trends plot showing the correlation between signal intensity and sample dose. FIG. 5B shows a trends plot 73 for a selected ion. A Scores Plot 75 as shown in FIG. 6 indicates the similarities between samples (such as a control sample and a dosed animal sample). The data in FIG. 6 shows the PCA of LC/MS data generated from rat urine obtained following the administration of vehicle alone or a candidate pharmaceutical at low and high dose. The display generated for a user visually indicates obvious points of similarity which are ascertainable with the naked eye. These suggestions of similarity may then form the basis for further study.

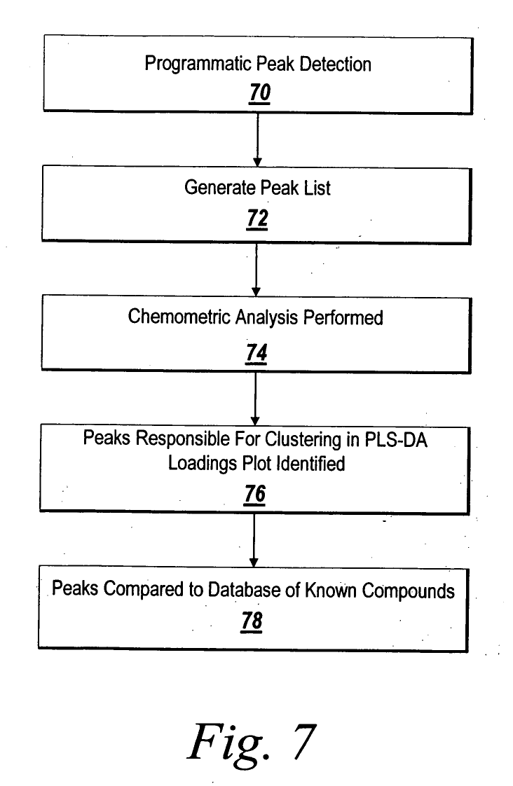

FIG. 7 is a flow chart of the overall sequence of steps followed by the illustrative embodiment of the present invention to perform metabonomics-directed processing of LC-MS or LC-MS/MS data. The sequence begins with the collection of raw LC-MS/MS data and the identification of actual LC and MS peaks as described above (step 70). A list of the identified peaks is then generated (step 72). This list forms the basis for the samples appearing in the Master Entity List. The samples are further filtered, undergoing isotope de-clustering and adduct removal, and chemometric analysis, such as PCA and PLS-DA analysis, is performed (step 74). Peaks responsible for clustering in PLS-DA loadings are identified (step 76). The peaks are then compared to a database of known endogenous biochemicals in order to identify the compound associated with the peak (step 78). The compounds may be toxic compounds, drugs, chemicals, agricultural chemicals or other compounds. A compound database may be generated from the identified compounds containing retention times, m/z values with accurate mass where appropriate and other biological parameters such as sex, dose levels, day, and toxin. Those skilled in the art will recognize that identified biomarkers may be used in a number of different areas of science such as Metabolomics, Functional Genomics, Peptidomics and Proteomics.

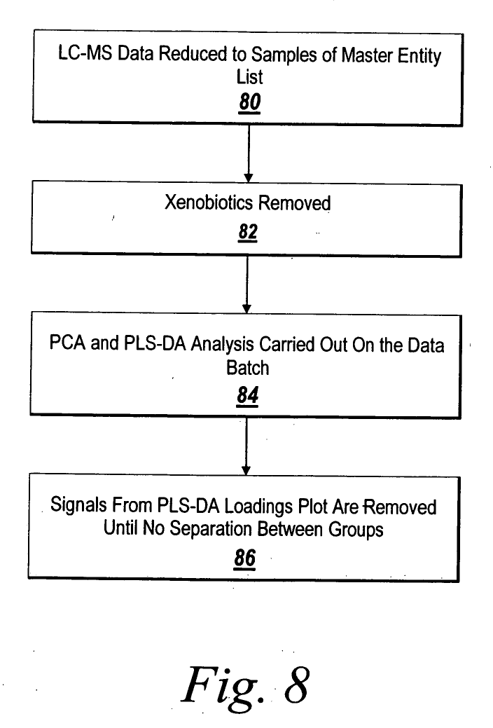

The chemometric analysis performed by the illustrative embodiment of the present invention is further shown in FIG. 8. The sequence of chemometric analysis steps begins when the LC-MS data is reduced to the samples of the Master Entity List (step 80). Xenobiotics are then removed from the samples to leave only the endogenous metabolites (step 82). PCA and PLS-DA analysis is then carried out on the data batch (step 84). Signals from the PLS-DA plot furthest away from the clusters are removed until there is no separation between groups (step 86).

A user of the Toxicological Screening and Biomarker Identifier Application 20 may thus easily transition between raw data, filtered data and analyzed data all by selecting the appropriate view. Conventional software packages lack this integration between the raw and filtered data and the analyzed data since two or more separate software packages are required for the task. The requirement of two or more software packages presents a user with difficulty in mapping from analyzed data to the corresponding spot in the raw data.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. In a metabolite analysis system, a method, comprising the steps of:
programmatically identifying chromatography peaks and mass spectrometry peaks from a sample run; said mass spectrometry peak being one of an MS peak and MS/MS peak and using nominal or exact mass;
generating a list of sample data having said identified peaks;
performing chemometric analysis on said sample data to identify biomarkers; said chemometric analysis performed without loss of retention time data by the same application performing the programmatic identification of said chromatography and mass spectrometry peaks.

2. The method of claim 1 wherein said chemometric analysis is performed using one of Principle Component Analysis (PCA) and Partial Least Squares Discriminate Analysis (PLS-DA).

3. The method of claim 1, comprising the further steps of:
comparing said identified biomarkers with a database of known compounds.

4. The method of claim 1, comprising the further step of:
removing unwanted material traces from the sample data prior to performing chemometric analysis.

5. The method of claim 1 wherein said unwanted material traces are at least one of xenobiotic traces, dosing vehicle traces, extraneous food traces, and contamination traces.

6. The method of claim 1 wherein said sample data includes mass data, retention time and signal intensity values.

7. The method of claim 1 wherein said biomarkers are used in Systems Biology.

8. The method of claim 1 wherein said chemometric analysis further comprises the steps of:
plotting said sample data on an n-dimensional plot, said n-dimensional plot indicating the analyte peaks of a plurality of said biomarkers.

9. A medium in a metabolite analysis system, said medium holding executable steps for a method, said method comprising the steps of:
programmatically identifying chromatography peaks and mass spectrometry peaks from a sample run; said mass spectrometry peak being one of an MS peak and MS/MS peak and using nominal or exact mass;
generating a list of sample data having said identified peaks;
performing chemometric analysis on said sample data to identify biomarkers;
said chemometric analysis performed without loss of retention time data by the same application performing the programmatic identification of said chromatography and mass spectrometry peaks.

10. The medium of claim 9 wherein said chemometric analysis is performed using one of Principle Component Analysis (PCA) and Partial Least Squares Discriminate Analysis (PLS-DA).

11. The medium of claim 9, wherein said method comprises the further steps of:
comparing said identified biomarkers with a database of known compounds.

12. The medium of claim 9, wherein said method comprises the further step of:
removing unwanted material traces from the sample data prior to performing chemometric analysis.

13. The medium of claim 9 wherein said unwanted material traces are at least one of xenobiotic traces, dosing vehicle traces, extraneous food traces, and contamination traces.

14. The medium of claim 9 wherein said sample data includes mass data, retention time and signal intensity values.

15. The medium of claim 9 wherein said biomarkers are used in Systems Biology.

16. The medium of claim 9 wherein said chemometric analysis further comprises the steps of:
plotting said sample data on an n-dimensional plot, said n-dimensional plot indicating the analyte peaks of a plurality of said biomarkers.

17. A metabolite analysis system, comprising:
one of a chromatography-mass spectroscopy type system, MALDI-MS Matrix Assisted Laser Desorption/Ionization-Mass Spectroscopy) system, and DIOS-MS (Desorption Ionization On Silicon) System;
a toxicological screening and biomarker identification facility, said toxicological and biomarker identification facility programmatically identifying analyte peaks and mass spectroscopy peaks from at least one sample run performed on said one of a chromatography-mass spectroscopy type system, MALDI-MS system, and DIOS-MS system, said toxicological and biomarker identification facility further performing chemometric analysis on said sample data to identify biomarkers, said chemometric analysis performed without loss of retention time data; and
a storage location accessible to said toxicological and biomarker identification facility holding a collection of raw and filtered data from said at least one sample run performed on said one of a chromatography-mass spectroscopy type system, MALDI-MS system, and DIOS-MS system.

18. The system of claim 17 wherein said toxicological and biomarker identification facility is implemented in software on an electronic device interfaced with said one of a chromatography-mass spectroscopy type system, MALDI-MS system, and DIOS-MS system.

19. The system of claim 17 wherein said collection of raw and filtered data includes mass data, retention time and signal intensity values.

20. The system of claim 17 wherein said biomarkers are used in at least one of Metabonomics, Proteomics, Functional Genomics, Lipidomics, Glycomics, Metabolomics and endogenous peptide profiling.
